(19) United States
(12) Patent Application Publication
(10) Pub. No.: US 2026/0338157 A1
(43) Pub. Date: Oct. 29, 2026

(54) INTEGRATED PLAN-CONTROL METHOD FOR DYNAMIC STABILITY OF FLOATING WIND TURBINES

(71) Applicant: ZHEJIANG UNIVERSITY, Hangzhou (CN)

(72) Inventors: Lilin WANG, Hangzhou (CN); Songyue ZHENG, Hangzhou (CN); Lizhong WANG, Hangzhou (CN); Lijian WU, Hangzhou (CN); Yi HONG, Hangzhou (CN)

(73) Assignee: ZHEJIANG UNIVERSITY, Hangzhou (CN)

(21) Appl. No.: 19/698,944

(22) Filed: Jun. 5, 2026

Related U.S. Application Data
(63) Continuation of application No. PCT/CN2025/094620, filed on May 13, 2025.

(30) Foreign Application Priority Data
Apr. 18, 2025 (CN) 202510487234.1

(51) Int. Cl. F03D 7/02; B63B 35/44; F03D 13/25

(52) U.S. Cl. CPC F03D 7/0224; B63B 35/44; F03D 13/256; B63B 2035/446; F05B 2240/93; F05B 2260/70

(57) ABSTRACT

Provided is an integrated plan-control method for dynamic stability of floating wind turbines. An integrated planner is externally connected to a controller to coordinately and dynamically tune core control parameters of a blade pitch sub-control system, a generator torque sub-control system, and a nacelle yaw sub-control system. A planner based on a nonlinear dynamic mathematical model can be employed to dynamically tune the controller parameter, thereby achieving comprehensive optimization of the dynamic stability objective. Without altering the existing industry-standard controller architecture of the floating wind turbines, the method comprehensively improves the dynamic stability of the floating wind turbines by dynamically tuning a series of core control parameters of the industry-standard controller. The method suppresses the motion of a floating platform-support structure, mitigates the fluctuation of a rotor speed/active power, and enhances the operational stability and energy efficiency of the floating wind turbines, exhibiting significant engineering application value.

### CROSS REFERENCE TO THE RELATED APPLICATIONS

This application is the continuation application of International Application No. PCT/CN2025/094620, filed on May 13, 2025, which is based upon and claims priority to Chinese Patent Application No. 202510487234.1, filed on Apr. 18, 2025, the entire contents of which are incorporated herein by reference.

### TECHNICAL FIELD

The present disclosure relates to an industry-standard controller design method, and in particular to an integrated plan-control method for dynamic stability of floating wind turbines.

### BACKGROUND

China has abundant deep-water offshore wind energy resources with huge development potential, and the development of deep-water offshore wind resources is of great significance for addressing global climate change. The development of offshore wind energy mainly employs two types of wind turbines classified according to their foundations: fixed wind turbines and floating wind turbines. Fixed wind turbines feature relatively mature technologies and are mainly suitable for shallow near-shore waters. However, as the water depth of developable sea areas continues to increase, the construction difficulty and cost of fixed wind turbines rise sharply, which considerably restricts their application in deep-water offshore areas. When the water depth increases to 50-100 m, floating wind turbines become the key to the development of deep-water offshore wind energy. Floating wind turbines are subject to significant wind-wave-current coupling effects, especially large-scale wind turbines with prominent structural flexibility and disposed on a floating platform. The influence of platform motions cannot be taken into account during the core parameter design phase of the control system, making it difficult for wind turbines to achieve the desired operating state in actual operation and presenting challenges to the dynamically stable operation of the floating wind turbines.

For the dynamically stable operation of fixed wind turbines, methods such as Maximum Power Point Tracking (MPPT) control, active damping control for tower structure, and individual pitch control (IPC) are mainly adopted. The Chinese Patent Application No. CN118092147B proposes a design method for an industry-standard planning controller for an offshore wind turbine, which improves the operating performance of the offshore wind turbines without altering the existing industry-standard control architecture. However, floating wind turbines are disposed on a floating platform, which are more susceptible to wave-induced roll and pitch motions. Such motions degrade the operational stability of the wind turbine system, and the solution proposed in the aforementioned patent cannot address this issue. Furthermore, the control system of floating wind turbines mainly includes a blade pitch control sub-control system, a generator torque control sub-control system, and a nacelle yaw control sub-control system. The stability of the floating platform of the floating wind turbines can be comprehensively enhanced by coordinating these three sub-control systems.

The industry-standard control architecture of existing floating wind turbine is as follows. Below the rated wind speed, the control system tracks the optimal tip-speed ratio for maximum wind power capture, while above the rated wind speed, the wind turbine is maintained at a rated active power production and a rated rotor speed. On this basis, the control system further accounts for the influence of platform motions on the dynamic response of the entire wind turbine, and adds a pitch damping control loop for the floating platform to the blade pitch control loop. The dynamic pitch damping control loop added for the floating platform only optimizes platform pitch to a limited extent, provides limited suppression of overall platform motions, and degrades the stability of the rotor speed/active power. To optimize the operating performance of the wind turbine and bring its actual performance close to the theoretical design value, parameter tuning control algorithms, such as fuzzy self-adaptive control, sliding mode variable structure control, and model reference self-adaptive control, have been proposed successively. However, such parameters tuning control algorithms alter the existing industry-standard controller architecture and pose potential risks of operational failure for the wind turbines, making such schemes difficult to accept by wind turbine manufacturers and wind farm owners.

### SUMMARY

To solve the above technical problems existing in the prior art, the present disclosure provides an integrated plan-control method for dynamic stability of floating wind turbines. The present disclosure aims to address the issue that theoretical design parameters of existing industry-standard control methods for floating wind turbines fail to consider floating platform motion during operation, leading to deviations in actual wind turbine control parameters and thereby deteriorating dynamic stability in terms of rotor speed/power and structural dynamics. Floating wind turbines can measure the dynamic responses of the rotor-generator system and the floating platform via a sensor during operation. Without altering the control algorithm architecture already adopted in the industry, the present disclosure aims to integrally and coordinately plan the core control parameters of blade pitch, generator torque, and nacelle yaw. The method can effectively utilize the dynamic response data acquired by the sensor to perform dynamic planning of the controller's core control parameters, thereby comprehensively enhancing the dynamic stability of floating wind turbines.

The present disclosure has the following beneficial effects:

The present disclosure provides an integrated plan-control method for dynamic stability of floating wind turbines. In terms of control, the method employs an industry-standard controller widely used in the industry, so as to maintain the mature controller schemes of existing turbine manufacturers and wind farm owners. An integrated planner is externally connected to the controller to coordinately and dynamically tune core control parameters of a blade pitch sub-control system, a generator torque sub-control system, and a nacelle yaw sub-control system. A planner based on a nonlinear dynamic mathematical model can be employed to dynamically tune the controller parameters, thereby achieving comprehensive optimization of the dynamic stability objective.

For multi-step prediction of the integrated planner, a state equation correlating a state variable of a floating platform-support structure system, a rotor-generator drive system, the blade pitch sub-control system, the generator torque sub-control system, and the nacelle yaw sub-control system of the floating wind turbines with the core control parameter of the industry-standard controller is established based on the nonlinear dynamic models of the rotor-generator drive system and the floating platform-support structure system, as well as the control strategies of the three sub-control systems. This achieves multi-step prediction from the core control parameter to the state variable. In accordance with the motion stability of the floating platform-support structure and the control objectives for mitigating the fluctuation of rotor speed/active power during operation of the floating wind turbines, the comprehensive optimization objective function and state constraint of the integrated planner are determined. Based on measured incoming wind speed, wave conditions, and other information, iterative optimization is carried out to obtain the controller parameter solution that minimizes the objective function. The optimal sequence of industry-standard controller parameters over multiple prediction steps is determined, and the first element of the optimal sequence is output as the controller parameter.

Without altering the existing industry-standard controller architecture of floating wind turbines, the present disclosure comprehensively improves the dynamic stability of the floating wind turbines by dynamically tuning a series of core control parameters of the industry-standard controller. The present disclosure suppresses the motion of the floating platform-support structure, mitigates the fluctuation of the rotor speed/active power, and enhances the operational stability and energy efficiency of the floating wind turbines, exhibiting significant engineering application value.

### BRIEF DESCRIPTION OF THE DRAWINGS

FIG. 1 is an architecture diagram of integrated plan-control for dynamic stability of floating wind turbines according to the present disclosure;

FIG. 2 is an operation time series diagram of an integrated plan-control system for the floating wind turbines;

FIG. 3 is a hardware architecture of the integrated plan-control system for the floating wind turbine;

FIG. 4 is a timing diagram of wind speed-wave external environment conditions of the floating wind turbines;

FIG. 5 is a comparison curve of core control parameter tuning for the floating wind turbine control system;

FIG. 6 is a timing diagram of comparison curves for power/speed, floating platform motion, and bending moments of key components.

### DETAILED DESCRIPTION OF THE EMBODIMENTS

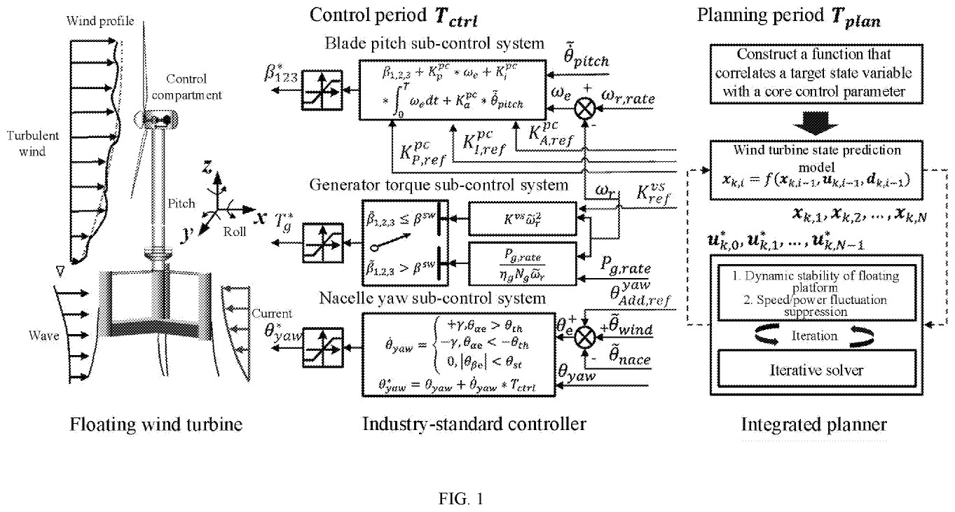

An embodiment of the present disclosure provides an integrated plan-control method for dynamic stability of floating wind turbines. FIG. 1 is an architecture diagram of integrated plan-control for a floating wind turbine according to the present disclosure.

The integrated plan-control method for dynamic stability of floating wind turbines specifically includes the following steps.

Step 1. An integrated plan-control architecture for a floating wind turbine is established, specifically including a controller and an integrated planner. The controller includes a blade pitch sub-control system, a generator torque sub-control system, and a nacelle yaw sub-control system. The integrated planner is configured to dynamically tune a core control parameter of each sub-control system of the controller.

Step 2. A comprehensive optimization objective function of the integrated planner of the floating wind turbines is established to suppress a motion of a floating platform-support structure and a fluctuation of a rotor speed/active power; and a nonlinear dynamic mathematical model of a floating platform-support structure system and a nonlinear dynamic mathematical model of a rotor-generator drive system are established based on the comprehensive optimization objective function of the integrated planner of the floating wind turbines.

Step 3. A state equation that correlates a state variable of the floating platform-support structure system, the rotor-generator drive system, the blade pitch sub-control system, the generator torque sub-control system, and the nacelle yaw sub-control system with the core control parameter is established based on the nonlinear dynamic mathematical model of the floating platform-support structure system, the nonlinear dynamic mathematical model of the rotor-generator drive system, and control strategies of the blade pitch sub-control system, the generator torque sub-control system, and the nacelle yaw sub-control system, and multi-step prediction is performed from the core control parameter to the state variable, and the comprehensive optimization objective function of the integrated planner of the floating wind turbines is iteratively solved based on a multi-step prediction result to determine a reference of the core control parameter.

The step 1 specifically includes the following sub-steps.

1-1. The controller is established. As shown in FIG. 1, under the architecture of the integrated plan-control method, the controller is an existing industry-standard controller to control the operation of the floating wind turbines. An input into the controller includes measured rotor speed \tilde{ω}ᵣ, measured wind speed \tilde{v}_{wind}, measured wind direction \tilde{θ}_{wind}, and the core control parameter of the controller. The controller outputs three blade pitch angle references

$${β}_{1}^{*} , {β}_{2}^{*} and {β}_{3}^{*} ( {β}_{1 , 2 , 3}^{*} ) ,$$

generator torque reference

$${T}_{g}^{*} ,$$

and a nacelle yaw angle reference

$${θ}_{Yaw}^{*} ,$$

for controlling the operation of the floating wind turbines. The core control parameter of the controller is dynamically tuned by the external integrated planner.

1-2. The blade pitch sub-control system, the generator torque sub-control system, and the nacelle yaw sub-control system of the floating wind turbines are reconstructed. The blade pitch sub-control system maintains the rotor speed ωᵣ at rated value ω_{r,rate} via proportional-integral (PI) and dynamically tunes structural damping of the floating platform in a pitch direction via proportional control. The generator torque sub-control system employs a segmented strategy, tracking maximum wind energy capture below a rated wind speed and maintaining a rated active power output P_{g,rate} above the rated wind speed by tuning a torque. The nacelle yaw sub-control system operates at fixed yaw rate γ (γ>0) to eliminate deviation angle θₑ between a rotor plane and a wind direction, thereby improving wind energy capture efficiency.

The control strategy of the blade pitch sub-control system can be expressed as two parts: speed error tracking PI control loop

$$( {K}_{P}^{p c} * {ω}_{e} + {K}_{I}^{p c} * {\int }_{0}^{T} {ω}_{e} dt )$$

and floating platform pitch damping tuning proportional loop

$${K}_{A}^{pc} * {\tilde{\dot{θ}}}_{pitch} ,$$

specifically expressed as:

$${β}_{1 , 2 , 3}^{*} = {β}_{1 , 2 , 3} + {K}_{P}^{pc} * {ω}_{e} + {K}_{I}^{pc} * {\int }_{0}^{T} {ω}_{e} dt + {K}_{A}^{pc} * {\tilde{\dot{θ}}}_{pitch} \qquad ( 1 )$$

where,

$${β}_{1 , 2 , 3}^{*}$$

denotes the blade pitch angle references; β_{1,2,3} denotes three real-time blade pitch angles; ωₑ=ω_{r,rate}−\tilde{ω}ᵣ denotes a rotor speed tracking error, and \tilde{ω}ᵣ denotes the measured rotor speed;

$${K}_{P}^{pc} , {K}_{I}^{pc} , and {K}_{A}^{pc}$$

denote a proportional gain coefficient of a pitch controller, an integral gain coefficient of the pitch controller, and a damping gain coefficient of the floating platform, respectively; \dot{\tilde{θ}}_{pitch} denotes a measured pitch angular velocity of the floating platform; and T denotes a cumulative operating time.

The control strategy of the generator torque sub-control system is to switch between a maximum wind energy capture strategy and a rated active power output strategy according to a blade pitch angle switching value β^{sw}, specifically expressed as:

$$\{ \begin{matrix}{T}_{g}^{*} = {K}^{vs} * {\tilde{ω}}_{r}^{2} , {\tilde{β}}_{1 , 2 , 3} \leq {β}^{sw} \\ {T}_{g}^{*} = {P}_{g , rate} / {( {\tilde{ω}}_{r} {N}_{g} η )}_{r} , {\tilde{β}}_{1 , 2 , 3} > {β}^{sw}\end{matrix} \qquad ( 2 )$$

where,

$${T}_{g}^{*}$$

denotes the generator torque reference; \tilde{β}_{1,2,3} denotes measured blade pitch angles; K^{vs} denotes an optimal torque coefficient below the rated wind speed; N_{g} denotes a gearbox ratio; and η denotes energy conversion efficiency of a generator.

The control strategy of the nacelle yaw sub-control system is to perform nacelle yaw at constant yaw rate γ and set corresponding nacelle yaw angle reference

$${θ}_{yaw}^{*} ,$$

specifically expressed as:

$${\dot{θ}}_{yaw} = \{ \begin{matrix}+ γ , & {θ}_{e α} > {θ}_{th} \\ - γ , & {θ}_{e α} < - {θ}_{th} \\ 0 , & \vert {θ}_{e β} \vert < {θ}_{st}\end{matrix} \qquad ( 3 )$$

$${θ}_{yaw}^{*} = {θ}_{yaw} + {\dot{θ}}_{yaw} * {T}_{ctrl} \qquad ( 4 )$$

where, \dot{θ}_{yaw} denotes a nacelle yaw rate reference;

$${θ}_{yaw}^{*}$$

denotes the nacelle yaw angle reference; θₜₕ denotes an error threshold for yaw activation; θₛₜ=θₜₕ/2 denotes an error threshold for yaw deactivation; T_{ctrl} denotes a control period of the industry-standard controller;

$${θ}_{e α} = \frac{1}{a} {\sum }_{j = 1}^{a} {θ}_{e}^{j}$$

denotes an average value of a equally spaced data within a sliding window at a current time for triggering yaw activation, and

$${θ}_{e β} = \frac{1}{b} {\sum }_{j = 1}^{b} {θ}_{e}^{j}$$

denotes an average value of b equally spaced data within the sliding window at the current time for triggering yaw deactivation, a<b; and

$${θ}_{e}^{j}$$

denotes a comprehensive error at a j-th time interval, related to yaw setpoint

$${θ}_{Add , ref , j}^{yaw}$$

at the j-th time interval, measured wind direction

$${\tilde{θ}}_{wind}^{j}$$

at the j-th time interval, and measured nacelle yaw angle

$${\tilde{θ}}_{nace}^{j}$$

at the j-th time interval,

$$( {θ}_{e}^{j} = {θ}_{Add , ref , j}^{yaw} + {\tilde{θ}}_{wind}^{j} - {\tilde{θ}}_{nace}^{j} )$$

1-3. The integrated planner is established, which can employ various optimization algorithms to iteratively optimize an optimal core control parameter of the controller in real time. The core control parameter specifically includes: proportional gain parameter

$${K}_{P}^{pc}$$

or the blade pitch sub-control system, integral gain parameter

$${K}_{I}^{pc}$$

of the blade pitch sub-control system, damping proportional gain

$${K}_{A}^{pc}$$

of the floating platform, optimal parameter K^{vs} of the generator torque sub-control system, and correction angle

$${θ}_{Add , ref}^{yaw}$$

of the nacelle yaw sub-control system form core control parameter vector u of the controller, specifically expressed as

$$u = {[ {K}_{P}^{pc} , {K}_{I}^{pc} , {K}_{A}^{pc} , {θ}_{Add , ref}^{yaw} ]}^{T} .$$

An input into the integrated planner includes a real-time operating state of the floating wind turbines measured by a sensor and a wind-wave-current environmental parameter; and the integrated planner outputs the core control parameter vector u, for tuning the core control parameter of the controller.

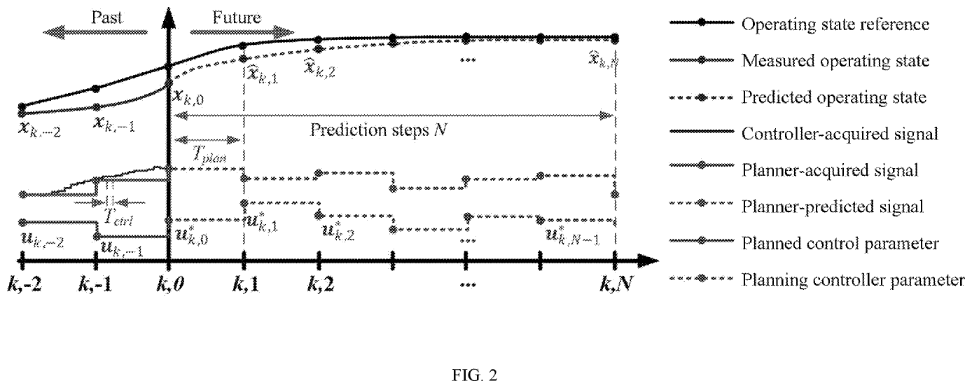

1-4. As shown in FIG. 2, the execution period Tₚₗₐₙ of the integrated planner is set to be greater than or equal to the control period T_{ctrl} of the industry-standard controller, where Tₚₗₐₙ=n*T_{ctrl}. That is, after the wind turbine executes control for n control periods, the core control parameter of the industry-standard controller is updated once.

The step 2 specifically includes the following substeps.

2-1. A comprehensive optimization objective function of the integrated planner of the floating wind turbines is established, to suppress motion of the floating platform-support structure and a fluctuation of a rotor speed/active power output through the coordinated action of the blade pitch sub-control system, the generator torque sub-control system, and the nacelle yaw sub-control system. The comprehensive optimization objective of suppressing the motion of the floating platform-support structure and suppressing the fluctuation of the rotor speed/active power is achieved by the integrated planner by tuning the core control parameter of the controller. The design of the comprehensive optimization objective function of the integrated planner of the floating wind turbines is not unique and can be defined as follows:

$$J = {min}_{{u}_{k , 0 : N - 1}^{*}} {\sum }_{i = 0}^{N} [ {Q}_{1} \vert {{\dot{θ}}_{pitch}}^{k , i} / {\dot{θ}}_{pitch , max} \vert + {Q}_{2} \cdot \vert {{\dot{θ}}_{roll}}^{k , i} / {\dot{θ}}_{roll , max} \vert + {Q}_{3} \cdot \vert ( {ω}_{r}^{k , i} - {ω}_{r}^{ref} ) / ( {σ}_{ω} \cdot {ω}_{r , rate} ) \vert + {Q}_{4} \cdot \vert {δ}^{k , i} / {δ}_{max} \vert + {Q}_{5} \cdot \vert {{\dot{β}}_{1 , 2 , 3}}^{k , i} / {\dot{β}}_{1 , 2 , 3 , max} \vert + {Q}_{6} \cdot \vert {{\dot{T}}_{g}}^{k , i} / {\dot{T}}_{g , max} \vert + {Q}_{7} \cdot \vert {{θ}_{Yaw}}^{k , i} / {θ}_{Yaw , max} \vert ] \qquad ( 5 )$$

where, J denotes an objective function value;

$${u}_{k , 0 : N - 1}^{*}$$

denotes a sequence of control parameter vectors for N ideal planning periods corresponding to a minimum objective function value; Q₁, Q₂, Q₃, Q₄, Q₅, Q₆, and Q₇ denote weight factors for floating platform pitch optimization, floating platform roll optimization, rotor speed optimization, drive train torsion angle optimization, blade pitch rate constraint optimization, generator torque rate constraint optimization, and nacelle yaw constraint optimization, respectively, and the weight factors are tuned according to a real-time external environmental characteristic based on a Pareto optimality theory;

$${{θ}_{pitch}}^{k , i} , {{θ}_{roll}}^{k , i} , {ω}_{r}^{k , i} , {δ}^{k , i} , {{β}_{1 , 2 , 3}}^{k , i} , {{T}_{g}}^{k , i} , and {{θ}_{Yaw}}^{k , i}$$

denote a pitch angular velocity of a floating platform, a roll angular velocity of the floating platform, the rotor speed, a drive train torsion angle, first-order derivatives of three blade pitch angles, a first-order derivative of a generator torque, and a nacelle yaw angle at an i-th prediction step of a k-th period, respectively; σ_{ω} denotes an allowable rotor speed deviation; and \dot{θ}_{pitch,max}, \dot{θ}_{roll,max}, δₘₐₓ, \dot{β}_{1,2,3,max}, \dot{T}_{g,max}, and θ_{yaw,max} denote maximum constraints for the pitch angular velocity of the floating platform, the roll angular velocity of the floating platform, the drive train torsion angle, the first-order derivatives of the three blade pitch angles, the first-order derivative of the generator torque, and the nacelle yaw angle, respectively. The first-order derivatives \dot{β}_{1,2,3}^{k,i} of the pitch angles and the first-order derivative \dot{T}_{g}^{k,i} of the generator torque at the i-th prediction step of the k-th period are expressed as follows:

$${{\dot{β}}_{1 , 2 , 3}}^{k , i} = ( {β}_{1 , 2 , 3}^{* , k , i} - {β}_{1 , 2 , 3}^{k , i - 1} ) / {t}_{au - pit} \qquad ( 6 )$$

$${{T}_{g}}^{k , i} = ( {T}_{g}^{* , k , i} - {T}_{g}^{k , i - 1} ) / {t}_{au - tor} \qquad ( 7 )$$

where, tₐᵤ₋ₚᵢₜ and tₐᵤ₋ₜₒᵣ denote time constants of a blade pitch actuator and a generator torque actuator, respectively;

$${β}_{1 , 2 , 3}^{* , k , i} and {T}_{g}^{* , k , i}$$

denote predicted pitch angle references and a predicted generator torque reference at the i-th prediction step of the k-th period, respectively; and

$${β}_{1 , 2 , 3}^{k , i - 1} and {T}_{g}^{k , i - 1}$$

denote predicted pitch angle states and a predicted generator torque state at an i−1-th prediction step of the k-th period, respectively.

2-2. The nonlinear dynamic mathematical model of the floating platform-support structure system subjected to a wind-wave factor is established, which is expressed by second-order ordinary differential dynamic equations of floating platform motion angles decoupled in the pitch and roll directions:

I_{pitch}\ddot{θ}_{pitch}+B_{pitch}\dot{θ}_{pitch}+C_{pitch}θ_{pitch}=H_{hub}Fₐₓ+M_{pitch} (8)

Iᵣₒₗₗ\ddot{θ}ᵣₒₗₗ+Bᵣₒₗₗ\dot{θ}ᵣₒₗₗ+Cᵣₒₗₗθᵣₒₗₗ=H_{hub}F_{ay}+Mᵣₒₗₗ (9)
where, I_{pitch}, B_{pitch}, and C_{pitch} denote a moment of inertia, equivalent damping, and a restoring coefficient of the floating platform in a pitch direction, respectively; Iᵣₒₗₗ, Bᵣₒₗₗ, and Cᵣₒₗₗ denote a moment of inertia, equivalent damping, and a restoring coefficient of the floating platform in a roll direction, respectively; \ddot{θ}_{pitch}, \dot{θ}_{pitch}, and θ_{pitch} denote a pitch angular acceleration, a pitch angular velocity, and a pitch angle of the floating platform, respectively; \ddot{θ}ᵣₒₗₗ, \dot{θ}ᵣₒₗₗ, and θᵣₒₗₗ denote a roll angular acceleration, a roll angular velocity, and a roll angle of the floating platform, respectively; M_{pitch} and Mᵣₒₗₗ denote wave-induced pitch and roll moments, respectively; H_{hub} denotes a height of a tower support structure; and Fₐₓ and F_{ay} denote equivalent thrusts on the floating platform in the pitch direction and the roll direction, respectively.

2-3. The nonlinear dynamic mathematical model of the rotor-generator drive system is specifically expressed as:

$${\dot{ω}}_{r} = \frac{{P}_{r} ( {ω}_{r} , β , {V}_{wind} )}{{ω}_{r} {J}_{r}} - \frac{{ω}_{r} {D}_{s}}{{J}_{r}} + \frac{{ω}_{g} {D}_{s}}{{J}_{r} {N}_{g}} - \frac{δ {K}_{s}}{{J}_{r}} \qquad ( 10 )$$

$$\begin{matrix}{\dot{ω}}_{g} = \frac{{ω}_{r} {D}_{s}}{{J}_{g} {N}_{g}} - \frac{{ω}_{g} {D}_{s}}{{J}_{g} {N}_{g}^{2}} + \frac{δ {K}_{s}}{{J}_{g} {N}_{g}} - \frac{{T}_{g}}{{J}_{g}} & ( 11 )\end{matrix}$$

$$\dot{δ} = {ω}_{r} - \frac{{ω}_{g}}{{N}_{g}} \qquad ( 12 )$$

where, Pᵣ denotes an aerodynamic power captured by a rotor, and is a function of the rotor speed ωᵣ, the blade pitch angles β, and a hub wind speed v_{wind}; ω_{g} denotes a generator speed; δ denotes the drive train torsion angle; Jᵣ and J_{g} denote moments of inertia of the rotor and a generator, respectively; Dₛ and Kₛ denote a damping coefficient and a stiffness coefficient of a drive train, respectively; N_{g} denotes a gearbox ratio; and \dot{ω}ᵣ, \dot{ω}_{g}, and \dot{δ} denote first-order derivatives of the rotor speed, the generator speed, and the drive train torsion angle, respectively.

The step 3 specifically includes the following sub-steps.

3-1) The state equation that correlates the state variable of the floating platform-support structure system, the rotor-generator drive system, the blade pitch sub-control system, the generator torque sub-control system, and the nacelle yaw sub-control system of the floating wind turbines with the core control parameter is established, specifically expressed as:

x_{k,i}=A_{k,i-1}x_{k,i-1}+B_{k,i-1}u_{k,i-1}+B_{d,k,i-1}d_{k,i-1} (13)
where,

$${x}_{k , i} = {[ {\dot{θ}}_{pitch}^{k , i} , {\dot{θ}}_{roll}^{k , i} {ω}_{r}^{k , i} , {δ}^{k , i} , {\dot{β}}_{1 , 2 , 3}^{k , i} , {\dot{T}}_{g}^{k , i} , {θ}_{yaw}^{k , i} ]}^{T}$$

denotes a state vector at the i-th prediction step of the k-th planning period

$$( i = 1 , 2 , … , N ) ; {u}_{k , i - 1} = {[ {K}_{P , k , i - 1}^{pc} , {K}_{I , k , i - 1}^{pc} , {K}_{A , k , i - 1}^{pc} , {K}_{k , i - 1}^{vs} , {θ}_{Add , ref , k , i - 1}^{yaw} ]}^{T}$$

denotes a core control parameter input vector of the controller at an (i−1)-th prediction step of the k-th planning period;

$${K}_{P , k , i - 1}^{pc} , {K}_{I , k , i - 1}^{pc} , {K}_{A , k , i - 1}^{pc} , {K}_{k , i - 1}^{vs} , and {θ}_{Add , ref , k , i - 1}^{yaw}$$

denote a proportional gain parameter of the blade pitch sub-control system, an integral gain parameter of the blade pitch sub-control system, a damping proportional gain of the floating platform, an optimal parameter of the generator torque sub-control system, and a correction angle of the nacelle yaw sub-control system at the i−1-th prediction step of the k-th planning period, respectively; d_{k,i-1}=[\tilde{v}_{wind}^{k,i-1}, \tilde{θ}_{wind}^{k,i-1}]^{T} denotes a disturbance input vector of the integrated planner at the (i−1)-th prediction step of the k-th planning period, where \tilde{v}_{wind}^{k,i-1} and \tilde{θ}_{wind}^{k,i-1} denote a measured wind speed and a measured wind direction at the (i−1)-th prediction step of the k-th planning period, respectively; and A_{k,i-1}, B_{k,i-1}, and B_{d,k,i-1} denote a state matrix, a core control parameter input matrix, and a disturbance input matrix at the (i−1)-th prediction step of the k-th planning period, respectively. Specifically, based on the control strategy equations of the blade pitch sub-control system, the generator torque sub-control system, and the nacelle yaw sub-control system, the nonlinear dynamic mathematical model of the floating platform-support structure system, and the nonlinear dynamic mathematical model of the rotor-generator drive system, the above equations and models are expanded by first-order Taylor expansion, terms related to the state vector are arranged into the state matrix, terms related to the core control parameter input vector of the controller are arranged into the core control parameter input matrix, and terms related to the disturbance input vector of the integrated planner are arranged into the disturbance input matrix.

3-2. The multi-step prediction is performed on the state variable based on the state equation obtained in the step 3-1, and a prediction result is limited within a constraint (if the prediction result exceeds the range, a prediction value higher than a maximum value is tuned to the maximum value and a value lower than the minimum value is tuned to a minimum value by tuning a control input parameter). A constraint is imposed on a finite control set of candidate given pitch angles, generator torques, and yaw angles of the floating wind turbines, as well as on the rotor speed, and pitch and roll angles of the floating platform, specifically expressed as:

\dot{β}_{1,2,3,min}≤\dot{β}_{1,2,3}≤\dot{β}_{1,2,3,max} (14)

\dot{T}_{g,min}≤\dot{T}_{g}≤\dot{T}_{g,max} (15)

\dot{θ}_{yaw,min}≤\dot{θ}_{yaw}≤\dot{θ}_{yaw,max} (16)

ωᵣ^{cutin}≤ωᵣ≤ω_{r,rate} (17)

θ_{pitch,min}≤θ_{pitch}≤θ_{pitch,max} (18)

θ_{roll,min}≤θᵣₒₗₗ≤θ_{roll,max} (19)
where, \dot{β}_{1,2,3,min}, \dot{T}_{g,min}, \dot{θ}_{yaw,min}, θ_{pitch,min}, and θ_{roll,min} denote minimum constraints of the first-order derivatives of the three blade pitch angles, the first-order derivative of the generator torque, the first-order derivative of the nacelle yaw angle, the pitch angular velocity of the floating platform, and the roll angular velocity of the floating platform, respectively; \dot{θ}_{yaw,max}, θ_{pitch,max}, and θ_{roll,max} denote maximum constraints of the first-order derivative of the nacelle yaw angle, the pitch angular velocity of the floating platform, and the roll angular velocity of the floating platform, respectively;

$${ω}_{r}^{cutin}$$

denotes a minimum rotor speed corresponding to a cut-in wind speed; and ω_{r,rate} denotes the rated value of the rotor speed.

3-3. The predicted state vector of the floating wind turbines obtained in the step 3-2 is substituted into the comprehensive optimization objective function of the integrated planner of the floating wind turbines, and the comprehensive optimization objective function is iteratively solved using solution algorithms such as quadratic programming, exhaustive method, gradient descent method, and intelligent optimization algorithm to obtain control parameter vector

$$U *= [ {u}_{k , 0}^{*} , {u}_{k , 1}^{*} , … , {u}_{k , N - 1}^{*} ]$$

for the N planning periods corresponding to a minimum function value. First element

$${u}_{k , 0}^{*}$$

in U* is taken as the reference of the core control parameter for an existing industry-standard control system of the floating wind turbines.

The integrated planner includes a fault recovery mechanism for ensuring normal operation in case of a fault or a communication problem in a control process. When the integrated planner fails to achieve an ideal control effect or communication between the controller and the integrated planner is interrupted, the integrated planner automatically cuts out and reverts to the controller (the original industry-standard control system). When the communication problem is resolved or the control effect of the integrated planner is restored, an original integrated plan-control mode is automatically resumed.

### Embodiment 1

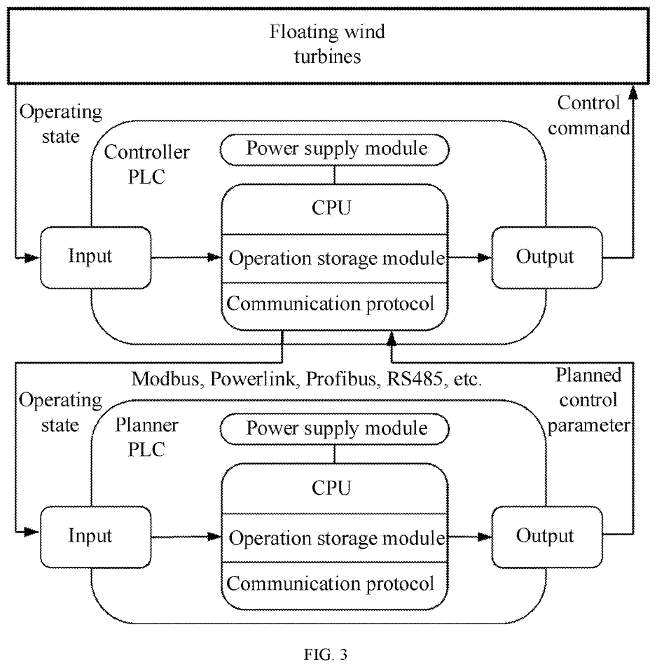

The integrated plan-control method for dynamic stability of floating wind turbines is implemented by an integrated plan-control system for a floating wind turbine, as shown in FIG. 3. The integrated plan-control system for a floating wind turbine includes two programmable logic controllers (PLCs) operating in parallel. Each PLC includes a power supply module, an input module, an output module, a central processing unit (CPU), an operation storage module, and a communication protocol. A first PLC acts as the controller. The operating state of the wind turbine measured by the sensor is transmitted to the input module, and wind turbine information is stored in the operation storage module. The CPU executes the control algorithm according to the period T_{ctrl}. The output module sends a control reference signal to the blade pitch sub-control system, the generator torque sub-control system, and the nacelle yaw sub-control system of the floating wind turbines. The second PLC acts as the integrated planner. The operating state of the wind turbine is transmitted from the operation storage module of the first PLC via the communication protocol (including Modbus, Powerlink, Profibus, RS485, etc.). The CPU executes the parameter iterative optimization algorithm according to the period Tₚₗₐₙ. The output module sends the core control parameter to the first PLC controller.

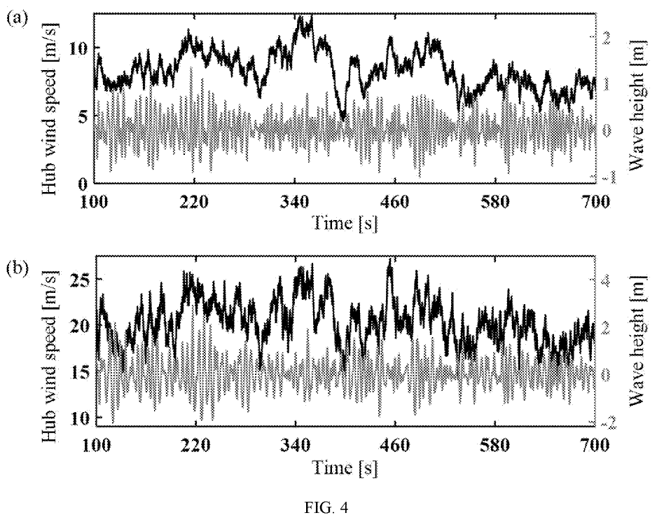

The above integrated plan-control system for a floating wind turbine is applied to an IEA-15MW floating wind turbine model. As shown in FIG. 4, the environmental parameters are set as follows: (a) an 8 m/s turbulent wind with a turbulence intensity of 19%, a peak wave height of 1.07 m, and a wave period of 5.89 s; and (b) a 20 m/s turbulent wind with a turbulence intensity of 14%, a peak wave height of 1.96 m, and a wave period of 7.12 s.

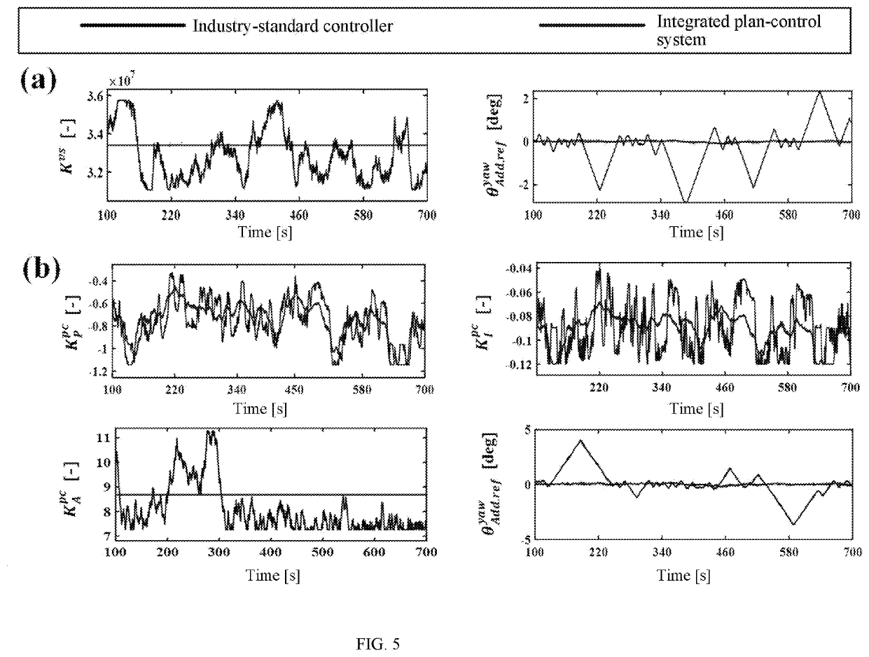

FIG. 5 shows a comparison of core control parameter tuning between the industry-standard controller and the integrated plan-control strategy of the present disclosure. (a) shows a comparison of tuning effects on the optimal torque coefficient K^{vs} of the generator torque sub-control system and the correction angle

$${θ}_{add , ref}^{yaw}$$

of the nacelle yaw sub-control system below the rated wind speed. (b) shows a comparison of tuning effects on the proportional gain

$${K}_{P}^{pc}$$

and the integral gain

$${K}_{I}^{pc}$$

of the pitch controller, the dampening gain

$${K}_{A}^{pc}$$

of the floating platform, and the correction angle

$${θ}_{Add , ref}^{yaw}$$

of the nacelle yaw sub-control system above the rated wind speed. It can be observed from FIG. 5 that, based on the time-series comparison of the core control parameter of the controller, the parameter variation amplitude of the integrated planner is significantly larger than that of the controller's own tuning. This indicates that the integrated planner can respond more actively to variations in the operating state of the floating wind turbines during dynamic tuning, thereby achieving higher-performance regulation.

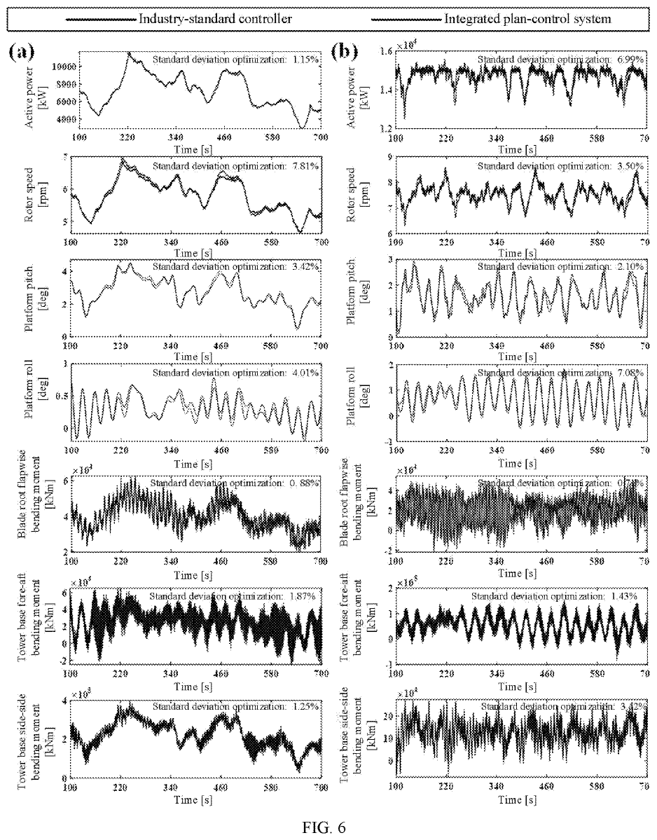

FIG. 6 shows real-time comparison curves of the active power, rotor speed, floating platform pitch, floating platform roll, blade root flapwise bending moment, tower base fore-aft bending moment, and tower base side-side bending moment under environmental parameters (a) and (b), as regulated by the industry-standard controller and the integrated planning controller. It can be seen from FIG. 6 that the integrated plan-control method for a floating wind turbine proposed by the present disclosure effectively suppresses the motions of the floating platform-support structure in the pitch and roll directions, and mitigates fluctuations in the rotor speed/active power. Therefore, the present disclosure reduces structural loads on key components such as blades and the tower induced by the motions of the floating platform, and comprehensively improves the operating performance of the floating wind turbines.

### Embodiment 2

The present disclosure further provides an electronic device, including one or more processors and a memory configured to store one or more programs, where when the one or more programs are executed by the one or more processors, the one or more processors implement the integrated plan-control method for dynamic stability of floating wind turbines.

### Embodiment 3

The present disclosure further provides a computer-readable storage medium, configured to store a computer instruction, where the computer instruction is executed by a computer to implement the integrated plan-control method for dynamic stability of floating wind turbines.

1. An integrated plan-control method for dynamic stability of floating wind turbines, comprising following steps:
step 1: establishing an integrated plan-control architecture for the floating wind turbine, comprising a controller and an integrated planner, wherein the controller comprises a blade pitch sub-control system, a generator torque sub-control system, and a nacelle yaw sub-control system; and the integrated planner is configured to dynamically tune a core control parameter of each sub-control system of the controller;
step 2: establishing a comprehensive optimization objective function of the integrated planner of the floating wind turbines to suppress a motion of a floating platform-support structure and a fluctuation of a rotor speed/active power; and establishing a nonlinear dynamic mathematical model of a floating platform-support structure system and a nonlinear dynamic mathematical model of a rotor-generator drive system based on the comprehensive optimization objective function of the integrated planner of the floating wind turbines; and
step 3: establishing a state equation that correlates a state variable of the floating platform-support structure system, the rotor-generator drive system, the blade pitch sub-control system, the generator torque sub-control system, and the nacelle yaw sub-control system of the floating wind turbines with the core control parameter, based on the nonlinear dynamic mathematical model of the floating platform-support structure system, the nonlinear dynamic mathematical model of the rotor-generator drive system, and control strategies of the blade pitch sub-control system, the generator torque sub-control system, and the nacelle yaw sub-control system, and performing multi-step prediction from the core control parameter to the state variable; and iteratively solving the comprehensive optimization objective function of the integrated planner of the floating wind turbines based on the multi-step prediction to determine a reference of the core control parameter;
wherein, in the step 2, the comprehensive optimization objective function of the integrated planner of the floating wind turbines is expressed as:
$$J = {min}_{{u}_{k , 0 : N - 1}^{*}} {\sum }_{i = 1}^{N} [ {Q}_{1} \cdot \vert {\dot{θ}}_{pitch}^{k , i} / {\dot{θ}}_{pitch , max} \vert + {Q}_{2} \cdot \vert {\dot{θ}}_{roll}^{k , i} / {\dot{θ}}_{roll , max} \vert + {Q}_{3} \cdot \vert ( {ω}_{r}^{k , i} - {ω}_{r}^{ref} ) / ( {σ}_{ω} \cdot {ω}_{r , rate} ) \vert + {Q}_{4} \cdot \vert {δ}^{k , i} / {δ}_{max} \vert + {Q}_{5} \cdot \vert {\dot{β}}_{1 , 2 , 3}^{k , i} / {\dot{β}}_{1 , 2 , 3 , max} \vert + {Q}_{6} \cdot \vert {\dot{T}}_{g}^{k , i} / {\dot{T}}_{g , max} \vert + {Q}_{7} \cdot \vert {θ}_{Yaw}^{k , i} / {θ}_{yaw , max} \vert ] \qquad ( 1 )$$
wherein, J denotes an objective function value;
$${u}_{k , 0 : N - 1}^{*}$$
denotes a sequence of control parameter vectors for N ideal planning periods corresponding to a minimum objective function value; Q₁, Q₂, Q₃, Q₄, Q₅, Q₆, and Q₇ denote weight factors for floating platform pitch optimization, floating platform roll optimization, rotor speed optimization, drive train torsion angle optimization, blade pitch rate constraint optimization, generator torque rate constraint optimization, and nacelle yaw constraint optimization, respectively, and the weight factors are tuned according to a real-time external environmental characteristic based on a Pareto optimality theory;
$${\dot{θ}}_{pitch}^{k , i} , {\dot{θ}}_{roll}^{k , i} , {ω}_{r}^{k , i} , {δ}^{k , i} , {\dot{β}}_{1 , 2 , 3}^{k , i} , {\dot{T}}_{g}^{k , i} , and {θ}_{Yaw}^{k , i}$$
denote a pitch angular velocity of a floating platform, a roll angular velocity of the floating platform, the rotor speed, a drive train torsion angle, first-order derivatives of three blade pitch angles, a first-order derivative of a generator torque, and a nacelle yaw angle at an i-th prediction step of a k-th period, respectively; σ_{ω} denotes an allowable rotor speed deviation; ω_{r,rate} is a rated value of the rotor speed; and \dot{θ}_{pitch,max}, \dot{θ}_{roll,max}, δₘₐₓ, \dot{β}_{1,2,3,max}, \dot{T}_{g,max}, and θ_{yaw,max} denote maximum constraints for the pitch angular velocity of the floating platform, the roll angular velocity of the floating platform, the drive train torsion angle, the first-order derivatives of the three blade pitch angles, the first-order derivative of the generator torque, and the nacelle yaw angle, respectively.

2. The integrated plan-control method for dynamic stability of the floating wind turbines according to claim 1, wherein the step 1 comprises following steps:
1) establishing the controller, wherein the controller is an industry-standard controller for the floating wind turbine; an input into the controller comprises a measured rotor speed \tilde{ω}ᵣ, a measured wind speed \tilde{v}_{wind}, a measured wind direction \tilde{θ}_{wind}, and the core control parameter of the controller; and an output from the controller comprises three blade pitch angle references
$${β}_{1}^{*} , {β}_{2}^{*} and {β}_{3}^{*} ,$$
a generator torque reference
$${T}_{g}^{*} ,$$
and a nacelle yaw angle reference θ_{Yaw}*, for controlling an operation of the floating wind turbines;
2) reconstructing the blade pitch sub-control system, the generator torque sub-control system, and the nacelle yaw sub-control system of the floating wind turbines, wherein the blade pitch sub-control system maintains the rotor speed or at the rated value ω_{r,rate} via proportional-integral (PI) and dynamically tunes structural damping of the floating platform in a pitch direction via proportional control; the generator torque sub-control system employs a segmented strategy, tracking maximum wind energy capture below a rated wind speed and maintaining a rated active power output P_{g,rate} above the rated wind speed by tuning a torque; and the nacelle yaw sub-control system operates at a fixed yaw rate γ to eliminate a deviation angle θₑ between a rotor plane and a wind direction, thereby improving wind energy capture efficiency, wherein γ>0;
3) establishing the integrated planner, wherein the integrated planner employs an optimization algorithm to iteratively search for an optimal core control parameter in real time; the core control parameter comprises: a proportional gain parameter
$${K}_{I}^{pc}$$
of the blade pitch sub-control system, an integral gain parameter
$${K}_{A}^{pc}$$
of the blade pitch sub-control system, and a damping proportional gain
$${K}_{A}^{p c}$$
of the floating platform, an optimal parameter K^{vs} of the generator torque sub-control system, and a correction angle
$${θ}_{Add , ref}^{yaw}$$
of the nacelle yaw sub-control system; an input into the integrated planner comprises a real-time operating state of the floating wind turbines measured by a sensor and a wind-wave-current environmental parameter; and the integrated planner outputs a core control parameter vector
$$u = {[ {K}_{P}^{pc} , {K}_{I}^{pc} , {K}_{A}^{pc} , {K}^{vs} , {θ}_{Add , ref}^{yaw} ]}^{T} ,$$
for tuning the core control parameter of the controller; and
4) setting an execution period Tₚₗₐₙ of the integrated planner and a control period T_{ctrl} of the controller, wherein Tₚₗₐₙ=n*T_{ctrl}.

3. The integrated plan-control method for dynamic stability of the floating wind turbines according to claim 2, wherein in the step 1, the control strategy of the blade pitch sub-control system is expressed as:
$${β}_{1 , 2 , 3}^{*} = {β}_{1 , 2 , 3} + {K}_{P}^{pc} * {ω}_{e} + {K}_{I}^{pc} * {\int }_{0}^{T} {ω}_{e} dt + {K}_{A}^{pc} * {\tilde{\dot{θ}}}_{pitch} \qquad ( 2 )$$
wherein,
$${β}_{1 , 2 , 3}^{*}$$
denotes the blade pitch angle references; β_{1,2,3} denotes three real-time blade pitch angles; ωₑ=ω_{r,rate}−\tilde{ω}ᵣ denotes a rotor speed tracking error, and \tilde{ω}ᵣ, denotes the measured rotor speed;
$${K}_{P}^{pc} , {K}_{I}^{pc} , and {K}_{A}^{pc}$$
denote a proportional gain coefficient of a pitch controller, an integral gain coefficient of the pitch controller, and a damping gain coefficient of the floating platform, respectively; \dot{\tilde{θ}}_{pitch} denotes a measured pitch angular velocity of the floating platform; and T denotes a cumulative operating time;
the control strategy of the generator torque sub-control system is to switch between a maximum wind energy capture strategy and a rated active power output strategy according to a blade pitch angle switching value β^{sw}, expressed as:
$$\{ \begin{matrix}{T}_{g}^{*} = {K}^{vs} * {\tilde{ω}}_{r}^{2} , {\tilde{β}}_{1 , 2 , 3} \leq {β}^{sw} \\ {T}_{g}^{*} = {P}_{g , rate} / ( {\tilde{ω}}_{r} {N}_{g} η ) , {\tilde{β}}_{1 , 2 , 3} > {β}^{sw}\end{matrix} \qquad ( 3 )$$
wherein,
$${T}_{g}^{*}$$
denotes the generator torque reference; \tilde{β}_{1,2,3} denotes measured blade pitch angles; K^{vs} denotes an optimal torque coefficient below the rated wind speed; N_{g} denotes a gearbox ratio; and η denotes energy conversion efficiency of a generator;
the control strategy of the nacelle yaw sub-control system is expressed as:
$${\dot{θ}}_{yaw} = \{ \begin{matrix}+ γ & , {θ}_{e α} > {θ}_{th} \\ - γ & , {θ}_{e α} < - {θ}_{th} \\ 0 & , \vert {θ}_{e β} \vert < {θ}_{st}\end{matrix} \qquad ( 4 )$$
$${θ}_{yaw}^{*} = {θ}_{yaw} + {\dot{θ}}_{yaw} * {T}_{ctrl} \qquad ( 5 )$$
wherein, \tilde{θ}_{yaw} denotes a nacelle yaw rate reference;
$${θ}_{yaw}^{*}$$
denotes the nacelle yaw angle reference; γ denotes a yaw rate setpoint; θₜₕ denotes an error threshold for yaw activation; θₛₜ=θₜₕ/2 denotes an error threshold for yaw deactivation;
$${θ}_{e α} = \frac{1}{α} {\sum }_{j = 1}^{a} {θ}_{e}^{j}$$
denotes an average value of a equally spaced data within a sliding window at a current time for triggering yaw activation, and
$${θ}_{e β} = \frac{1}{α} {\sum }_{j = 1}^{a} {θ}_{e}^{j}$$
denotes an average value of b equally spaced data within the sliding window at the current time for triggering yaw deactivation, a<b; and
$${θ}_{e}^{j}$$
denotes a comprehensive error at a j-th time interval, related to a yaw setpoint
$${θ}_{Add , ref , j}^{yaw}$$
at the j-th time interval, a measured wind direction
$${\tilde{θ}}_{wind}^{j}$$
at the J-th time interval, and a measured nacelle yaw angle
$${\tilde{θ}}_{nace}^{j}$$
at the j-th time interval,
$${θ}_{e}^{j} = {θ}_{Add , ref , j}^{yaw} + {\tilde{θ}}_{wind}^{j} - {\tilde{θ}}_{nace}^{j}$$

4. The integrated plan-control method for dynamic stability of the floating wind turbines according to claim 1, wherein
the first-order derivatives \dot{β}_{1,2,3}^{k,i} of the pitch angles and the first-order derivative \dot{T}_{g}^{k,i} of the generator torque at the i-th prediction step of the k-th period are calculated as follows:
$${\dot{β}}_{1 , 2 , 3}^{k , i} = ( {β}_{1 , 2 , 3}^{* , k , i} - {β}_{1 , 2 , 3}^{k , i - 1} ) / {t}_{au - pit} \qquad ( 6 )$$
$${\dot{T}}_{g}^{k , i} = ( {T}_{g}^{* , k , i} - {T}_{g}^{k , i - 1} ) / {t}_{au - tor} \qquad ( 7 )$$
wherein, tₐᵤ₋ₚᵢₜ and tₐᵤ₋ₜₒᵣ denote time constants of a blade pitch actuator and a generator torque actuator, respectively;
$${β}_{1 , 2 , 3}^{* , k , i} and {T}_{g}^{* , k , i}$$
denote predicted pitch angle references and a predicted generator torque reference at the i-th prediction step of the k-th period, respectively; and
$${β}_{1 , 2 , 3}^{k , i - 1} and {T}_{g}^{k , i - 1}$$
denotes predicted pitch angle states and a predicted generator torque state at an (i−1)-th prediction step of the k-th period, respectively.

5. The integrated plan-control method for dynamic stability of the floating wind turbines according to claim 4, wherein in the step 2, the nonlinear dynamic mathematical model of the floating platform-support structure system is expressed as:
I_{pitch}\ddot{θ}_{pitch}+B_{pitch}\dot{θ}_{pitch}+C_{pitch}θ_{pitch}=H_{hub}Fₐₓ+M_{pitch} (8)
Iᵣₒₗₗ\ddot{θ}ᵣₒₗₗ+Bᵣₒₗₗ\dot{θ}ᵣₒₗₗ+Cᵣₒₗₗθᵣₒₗₗ=H_{hub}F_{ay}+Mᵣₒₗₗ (9)
wherein, I_{pitch}, B_{pitch}, and C_{pitch} denote a moment of inertia, equivalent damping, and a restoring coefficient of the floating platform in a pitch direction, respectively; Iᵣₒₗₗ, Bᵣₒₗₗ, and Cᵣₒₗₗ denote a moment of inertia, equivalent damping, and a restoring coefficient of the floating platform in a roll direction, respectively; \ddot{θ}_{pitch}, \dot{θ}_{pitch}, and θ_{pitch} denote a pitch angular acceleration, a pitch angular velocity, and a pitch angle of the floating platform, respectively; \ddot{θ}ᵣₒₗₗ, \dot{θ}ᵣₒₗₗ, and θᵣₒₗₗ denote a roll angular acceleration, a roll angular velocity, and a roll angle of the floating platform, respectively; M_{pitch} and Mᵣₒₗₗ denote wave-induced pitch and roll moments, respectively; H_{hub} denotes a height of a tower support structure; and Fₐₓ and F_{ay} denote equivalent thrusts on the floating platform in the pitch direction and the roll direction, respectively.

6. The integrated plan-control method for dynamic stability of the floating wind turbines according to claim 4, wherein in the step 2, the nonlinear dynamic mathematical model of the rotor-generator drive system is expressed as:
$${\dot{ω}}_{r} = \frac{{P}_{r} ( {ω}_{r} , β , {V}_{wind} )}{{ω}_{r} Jr} - \frac{{ω}_{r} {D}_{s}}{Jr} + \frac{{ω}_{g} {D}_{s}}{{Jr}^{N} g} - \frac{δ {K}_{s}}{Jr} \qquad ( 10 )$$
$${\dot{ω}}_{g} = \frac{{ω}_{r} {D}_{s}}{{J}_{g} {N}_{g}} - \frac{{ω}_{g} {D}_{s}}{{J}_{g} {N}_{g}^{2}} + \frac{δ {K}_{s}}{{J}_{g} {N}_{g}} - \frac{{T}_{g}}{{J}_{g}} \qquad ( 11 )$$
$$\dot{δ} = {ω}_{γ} - \frac{{ω}_{g}}{{N}_{g}} \qquad ( 12 )$$
wherein, Pᵣ denotes an aerodynamic power captured by a rotor, and is a function of the rotor speed ωᵣ, the blade pitch angles β, and a hub wind speed v_{wind}; ω_{g} denotes a generator speed; δ denotes the drive train torsion angle; Jᵣ and J_{g} denote moments of inertia of the rotor and a generator, respectively; Dₛ and Kₛ denote a damping coefficient and a stiffness coefficient of a drive train, respectively; N_{g} denotes a gearbox ratio; and \dot{ω}ᵣ, \dot{ω}_{g}, and \dot{δ} denote first-order derivatives of the rotor speed, the generator speed, and the drive train torsion angle, respectively.

7. The integrated plan-control method for dynamic stability of the floating wind turbines according to claim 4, wherein the step 3 comprises following steps:
1) establishing the state equation that correlates the state variable of the floating platform-support structure system, the rotor-generator drive system, the blade pitch sub-control system, the generator torque sub-control system, and the nacelle yaw sub-control system of the floating wind turbines with the core control parameter, expressed as:
x_{k,i}=A_{k,i-1}x_{k,i-1}+B_{k,i-1}u_{k,i-1}+B_{d,k,i-1}d_{k,i-1} (13)
wherein,
$${x}_{k , i} = {[ {\dot{θ}}_{pitch}^{k , i} , {\dot{θ}}_{roll}^{k , i} {ω}_{r}^{k , i} , {δ}^{k , i} , {\dot{β}}_{1 , 2 , 3}^{k , i} , {\dot{T}}_{g}^{k , i} , {θ}_{yaw}^{k , i} ]}^{T}$$
denotes a state vector at the i-th prediction step of the k-th planning period; x_{k,i-1} denotes a state vector at the (i−1)-th prediction step of the k-th planning period;
$${u}_{k , i - 1} = {[ {K}_{P , k , i - 1}^{pc} , {K}_{I , k , i - 1}^{pc} , {K}_{A , k , i - 1}^{vc} , {θ}_{Add , ref , k , i - 1}^{yaw} ]}^{T}$$
denotes a core control parameter input vector of the controller at the (i−1)-th prediction step of the k-th planning period;
$${K}_{P , k , i - 1}^{pc} , {K}_{I , k , i - 1}^{pc} , {K}_{A , k , i - 1}^{pc} , {K}_{k , i - 1}^{vs} , and {θ}_{Add , ref , k , i - 1}^{yaw}$$
denote a proportional gain parameter of the blade pitch sub-control system, an integral gain parameter of the blade pitch sub-control system, a damping proportional gain of the floating platform, an optimal parameter of the generator torque sub-control system, and a correction angle of the nacelle yaw sub-control system at the (i−1)-th prediction step of the k-th planning period, respectively; d_{k,i-1}=[\tilde{v}_{wind}^{k,i-1}, \tilde{θ}_{wind}^{k,i-1}]^{T} denotes a disturbance input vector of the integrated planner at the (i−1)-th prediction step of the k-th planning period, wherein \tilde{v}_{wind}^{k,i-1} and \tilde{θ}_{wind}^{k,i-1} denote a measured wind speed and a measured wind direction at the (i−1)-th prediction step of the k-th planning period, respectively; and A_{k,i-1}, N_{k,i-1}, and B_{d,k,i-1} denote a state matrix, a core control parameter input matrix, and a disturbance input matrix at the (i−1)-th prediction step of the k-th planning period, respectively;
2) performing the multi-step prediction on the state variable based on the state equation obtained in the step 1), and limiting a prediction result within a constraint; and imposing a constraint on a finite control set of candidate given pitch angles, generator torques, and yaw angles of the floating wind turbines, as well as on the rotor speed, and pitch and roll angles of the floating platform, expressed as:
\dot{β}_{1,2,3,min}≤\dot{β}_{1,2,3}≤\dot{β}_{1,2,3,max} (14)
\dot{T}_{g,min}≤\dot{T}_{g}≤\dot{T}_{g,max} (15)
\dot{θ}_{yaw,min}≤\dot{θ}_{yaw}≤\dot{θ}_{yaw,max} (16)
ωᵣ^{cutin}≤ωᵣ≤ω_{r,rate} (17)
θ_{pitch,min}≤θ_{pitch}≤θ_{pitch,max} (18)
θ_{roll,min}≤θᵣₒₗₗ≤θ_{roll,max} (19)
wherein, \dot{β}_{1,2,3,min}, \dot{T}_{g,min}, \dot{θ}_{yaw,min}, θ_{pitch,min}, and θ_{roll,min} denote minimum constraints of the first-order derivatives of the three blade pitch angles, the first-order derivative of the generator torque, the first-order derivative of the nacelle yaw angle, the pitch angular velocity of the floating platform, and the roll angular velocity of the floating platform, respectively; \dot{θ}_{yaw,max}, θ_{pitch,max}, and θ_{roll,max} denote maximum constraints of the first-order derivative of the nacelle yaw angle, the pitch angular velocity of the floating platform, and the roll angular velocity of the floating platform, respectively;
$${ω}_{r}^{cutin}$$
denotes a minimum rotor speed corresponding to a cut-in wind speed; and ω_{r,rate} denotes the rated value of the rotor speed; and
3) substituting a predicted state vector of the floating wind turbines obtained in the step 2) into the comprehensive optimization objective function of the integrated planner of the floating wind turbines, and iteratively solving the comprehensive optimization objective function to obtain a control parameter vector
$${U}^{*} = [ {u}_{k , 0}^{*} , {u}_{k , 1}^{*} , … , {u}_{k , N - 1}^{*} ]$$
for the N planning periods corresponding to a minimum function value; and taking a first element
$${u}_{k}^{*}$$
in U* as the reference of the core control parameter for an existing industry-standard control system of the floating wind turbines.

8. The integrated plan-control method for dynamic stability of the floating wind turbines according to claim 1, wherein the integrated planner comprises a fault recovery mechanism for ensuring normal operation in case of a fault or a communication problem in a control process;
when the integrated planner fails to achieve an ideal control effect or communication between the controller and the integrated planner is interrupted, the integrated planner automatically cuts out and reverts to the controller; and when a control effect of the integrated planner is restored or the communication problem is resolved, a control mode of the integrated planner is automatically resumed.

9. An electronic device, comprising:
one or more processors; and
a memory, configured to store one or more programs;
wherein, when the one or more programs are executed by the one or more processors, the one or more processors implement the method according to claim 1.

10. A computer-readable storage medium, configured to store a computer instruction, wherein the computer instruction is executed by a computer to implement steps of the method according to claim 1.

11. The electronic device according to claim 9, wherein in the integrated plan-control method for dynamic stability of the floating wind turbines, the step 1 comprises following steps:
1) establishing the controller, wherein the controller is an industry-standard controller for the floating wind turbine; an input into the controller comprises a measured rotor speed \tilde{ω}ᵣ, a measured wind speed \tilde{v}_{wind}, a measured wind direction \tilde{θ}_{wind}, and the core control parameter of the controller; and an output from the controller comprises three blade pitch angle references
$${β}_{1}^{*} , {β}_{2}^{*} and {β}_{3}^{*} ,$$
a generator torque reference
$${T}_{g}^{*} ,$$
and a nacelle yaw angle reference
$${θ}_{Y a w}^{*} ,$$
for controlling an operation of the floating wind turbines;
2) reconstructing the blade pitch sub-control system, the generator torque sub-control system, and the nacelle yaw sub-control system of the floating wind turbines, wherein the blade pitch sub-control system maintains the rotor speed or at the rated value ω_{r,rate} via proportional-integral (PI) and dynamically tunes structural damping of the floating platform in a pitch direction via proportional control; the generator torque sub-control system employs a segmented strategy, tracking maximum wind energy capture below a rated wind speed and maintaining a rated active power output P_{g,rate} above the rated wind speed by tuning a torque; and the nacelle yaw sub-control system operates at a fixed yaw rate γ to eliminate a deviation angle θₑ between a rotor plane and a wind direction, thereby improving wind energy capture efficiency, wherein γ>0;
3) establishing the integrated planner, wherein the integrated planner employs an optimization algorithm to iteratively search for an optimal core control parameter in real time; the core control parameter comprises: a proportional gain parameter
$${K}_{P}^{p c}$$
of the blade pitch sub-control system, an integral gain parameter
$${K}_{I}^{p c}$$
of the blade pitch sub-control system, and a damping proportional gain
$${K}_{A}^{p c}$$
of the floating platform, an optimal parameter K^{vs} of the generator torque sub-control system, and a correction angle
$${θ}_{A dd , ref}^{y a w}$$
of the nacelle yaw sub-control system; an input into the integrated planner comprises a real-time operating state of the floating wind turbines measured by a sensor and a wind-wave-current environmental parameter; and the integrated planner outputs a core control parameter vector
$$u = {[ {K}_{P}^{p c} , {K}_{I}^{p c} , {K}_{A}^{p c} , {K}^{v s} , {θ}_{A dd , ref}^{y a w} ]}^{T} ,$$
for tuning the core control parameter of the controller; and
4) setting an execution period Tₚₗₐₙ of the integrated planner and a control period T_{ctrl} of the controller, wherein Tₚₗₐₙ=n*T_{ctrl}.

12. The electronic device according to claim 11, wherein in the integrated plan-control method for dynamic stability of the floating wind turbines, in the step 1, the control strategy of the blade pitch sub-control system is expressed as:
$${β}_{1 , 2 , 3}^{*} = {β}_{1 , 2 , 3} + {K}_{P}^{p c} * {ω}_{e} + {K}_{I}^{p c} * {\int }_{0}^{T} {ω}_{e} d t + {K}_{A}^{p c} * {\tilde{\dot{θ}}}_{pitch} \qquad ( 2 )$$
wherein,
$${β}_{1 , 2 , 3}^{*}$$
denotes the blade pitch angle references; β_{1,2,3} denotes three real-time blade pitch angles; ωₑ=ω_{r,rate}−\tilde{ω}ᵣ denotes a rotor speed tracking error, and \tilde{ω}ᵣ denotes the measured rotor speed;
$${K}_{P}^{p c} , {K}_{I}^{p c} , and {K}_{A}^{p c}$$
denote a proportional gain coefficient of a pitch controller, an integral gain coefficient of the pitch controller, and a damping gain coefficient of the floating platform, respectively; \dot{\tilde{θ}}_{pitch} denotes a measured pitch angular velocity of the floating platform; and T denotes a cumulative operating time;
the control strategy of the generator torque sub-control system is to switch between a maximum wind energy capture strategy and a rated active power output strategy according to a blade pitch angle switching value β^{sw}, expressed as:
$$\{ \begin{matrix}{T}_{g}^{*} = {K}^{v s} * {\tilde{ω}}_{r}^{2} , {\tilde{β}}_{1 , 2 , 3} \leq {β}^{s w} \\ {T}_{g}^{*} = {P}_{g , rate} / ( {\tilde{ω}}_{r} {N}_{g} η ) , {\tilde{β}}_{1 , 2 , 3} > {β}^{s w}\end{matrix} \qquad ( 3 )$$
wherein,
$${T}_{g}^{*}$$
denotes the generator torque reference; \tilde{β}_{1,2,3} denotes measured blade pitch angles; K^{vs} denotes an optimal torque coefficient below the rated wind speed; N_{g} denotes a gearbox ratio; and n denotes energy conversion efficiency of a generator;
the control strategy of the nacelle yaw sub-control system is expressed as:
$${\dot{θ}}_{yaw} = \{ \begin{matrix}+ γ , & {θ}_{e α} > {θ}_{th} \\ - γ , & {θ}_{e α} < - {θ}_{th} \\ 0 , & \vert {θ}_{e β} \vert < {θ}_{st}\end{matrix} \qquad ( 4 )$$
$${θ}_{yaw}^{*} = {θ}_{yaw} + {\dot{θ}}_{yaw} * {T}_{ctrl} \qquad ( 5 )$$
wherein, \dot{θ}_{yaw} denotes a nacelle yaw rate reference;
$${θ}_{yaw}^{*}$$
denotes the nacelle yaw angle reference; γ denotes a yaw rate setpoint; θₜₕ denotes an error threshold for yaw activation; θₛₜ=θₜₕ/2 denotes an error threshold for yaw deactivation;
$${θ}_{e α} = \frac{1}{a} {\sum }_{j = 1}^{a} {θ}_{e}^{j}$$
denotes an average value of a equally spaced data within a sliding window at a current time for triggering yaw activation, and
$${θ}_{e β} = \frac{1}{b} {\sum }_{j = 1}^{b} {θ}_{e}^{j}$$
denotes an average value of b equally spaced data within the sliding window at the current time for triggering yaw deactivation, a<b; and
$${θ}_{e}^{j}$$
denotes a comprehensive error at a j-th time interval, related to a yaw setpoint
$${θ}_{Add , ref , j}^{yaw}$$
at the j-th time interval, a measured wind direction
$${\tilde{θ}}_{wind}^{j}$$
at the j-th time interval, and a measured nacelle yaw angle
$${\tilde{θ}}_{nace}^{j}$$
at the j-th time interval,
$${θ}_{e}^{j} = {θ}_{Add , ref , j}^{yaw} + {\tilde{θ}}_{wind}^{j} - {\tilde{θ}}_{nace}^{j} .$$

13. The electronic device according to claim 9, wherein in the integrated plan-control method for dynamic stability of the floating wind turbines,
the first-order derivatives \dot{β}_{1,2,3}^{k,i} of the pitch angles and the first-order derivative \dot{T}_{g}^{k,i} of the generator torque at the i-th prediction step of the k-th period are calculated as follows:
$${\dot{β}}_{1 , 2 , 3}^{k , i} = ( {β}_{1 , 2 , 3}^{* , k , i} - {β}_{1 , 2 , 3}^{k , i - 1} ) / {t}_{au - pit} \qquad ( 6 )$$
$${\dot{T}}_{g}^{k , i} = ( {T}_{g}^{* , k , i} - {T}_{g}^{k , i - 1} ) / {t}_{au - tor} \qquad ( 7 )$$
wherein, tₐᵤ₋ₚᵢₜ and tₐᵤ₋ₜₒᵣ denote time constants of a blade pitch actuator and a generator torque actuator, respectively;
$${β}_{1 , 2 , 3}^{* , k , i} and {T}_{g}^{* , k , i}$$
predicted pitch angle references and a predicted generator torque reference at the i-th prediction step of the k-th period, respectively; and
$${β}_{1 , 2 , 3}^{k , i - 1} and {T}_{g}^{k , i - 1}$$
denote predicted pitch angle states and a predicted generator torque state at an (i−1)-th prediction step of the k-th period, respectively.

14. The electronic device according to claim 13, wherein in the integrated plan-control method for dynamic stability of the floating wind turbines, in the step 2, the nonlinear dynamic mathematical model of the floating platform-support structure system is expressed as:
I_{pitch}\ddot{θ}_{pitch}+B_{pitch}\dot{θ}_{pitch}+C_{pitch}θ_{pitch}=H_{hub}Fₐₓ+M_{pitch} (8)
Iᵣₒₗₗ\ddot{θ}ᵣₒₗₗ+Bᵣₒₗₗ\dot{θ}ᵣₒₗₗ+Cᵣₒₗₗθᵣₒₗₗ=H_{hub}F_{ay}+Mᵣₒₗₗ (9)
wherein, I_{pitch}, B_{pitch}, and C_{pitch} denote a moment of inertia, equivalent damping, and a restoring coefficient of the floating platform in a pitch direction, respectively; Iᵣₒₗₗ, Bᵣₒₗₗ, and Cᵣₒₗₗ denote a moment of inertia, equivalent damping, and a restoring coefficient of the floating platform in a roll direction, respectively; \ddot{θ}_{pitch}, \dot{θ}_{pitch}, and θ_{pitch} denote a pitch angular acceleration, a pitch angular velocity, and a pitch angle of the floating platform, respectively; \ddot{θ}ᵣₒₗₗ, \dot{θ}ᵣₒₗₗ, and θᵣₒₗₗ denote a roll angular acceleration, a roll angular velocity, and a roll angle of the floating platform, respectively; M_{pitch} and Mᵣₒₗₗ denote wave-induced pitch and roll moments, respectively; H_{hub} denotes a height of a tower support structure; and Fₐₓ and F_{ay} denote equivalent thrusts on the floating platform in the pitch direction and the roll direction, respectively.

15. The electronic device according to claim 13, wherein in the integrated plan-control method for dynamic stability of the floating wind turbines, in the step 2, the nonlinear dynamic mathematical model of the rotor-generator drive system is expressed as:
$${\dot{ω}}_{r} = \frac{{P}_{r} ( {ω}_{r} , β , {V}_{wind} )}{{ω}_{r} {J}_{r}} - \frac{{ω}_{r} {D}_{s}}{{J}_{r}} + \frac{{ω}_{g} {D}_{s}}{{J}_{r} {N}_{g}} - \frac{δ {K}_{s}}{{J}_{r}} \qquad ( 10 )$$
$${\dot{ω}}_{g} = \frac{{ω}_{r} {D}_{s}}{{J}_{g} {N}_{g}} - \frac{{ω}_{g} {D}_{s}}{{J}_{g} {N}_{g}^{2}} + \frac{δ {K}_{s}}{{J}_{g} {N}_{g}} - \frac{{T}_{g}}{{J}_{g}} \qquad ( 11 )$$
$$\dot{δ} = {ω}_{r} - \frac{{ω}_{g}}{{N}_{g}} \qquad ( 12 )$$
wherein, Pᵣ denotes an aerodynamic power captured by a rotor, and is a function of the rotor speed ωᵣ, the blade pitch angles β, and a hub wind speed v_{wind}; ω_{g} denotes a generator speed; δ denotes the drive train torsion angle; Jᵣ and J_{g} denote moments of inertia of the rotor and a generator, respectively; Dₛ and Kₛ denote a damping coefficient and a stiffness coefficient of a drive train, respectively; N_{g} denotes a gearbox ratio; and \dot{ω}ᵣ, \dot{ω}_{g}, and \dot{δ} denote first-order derivatives of the rotor speed, the generator speed, and the drive train torsion angle, respectively.

16. The electronic device according to claim 13, wherein in the integrated plan-control method for dynamic stability of the floating wind turbines, the step 3 comprises following steps:
1) establishing the state equation that correlates the state variable of the floating platform-support structure system, the rotor-generator drive system, the blade pitch sub-control system, the generator torque sub-control system, and the nacelle yaw sub-control system of the floating wind turbines with the core control parameter, expressed as:
x_{k,i}=A_{k,i-1}x_{k,i-1}+B_{k,i-1}u_{k,i-1}+B_{d,k,i-1}d_{k,i-1} (13)
wherein,
$${x}_{k , i} = {[ {\dot{θ}}_{pitch}^{k , i} , {\dot{θ}}_{roll}^{k , i} {ω}_{r}^{k , i} , {δ}^{k , i} , {\dot{β}}_{1 , 2 , 3}^{k , i} , {\dot{T}}_{g}^{k , i} , {θ}_{yaw}^{k , i} ]}^{T}$$
denotes a state vector at the i-th prediction step of the k-th planning period; x_{k,i-1} denotes a state vector at the (i−1)-th prediction step of the k-th planning period,
$${u}_{k , i - 1} = {[ {K}_{P , k , i - 1}^{p c} , {K}_{I , k , i - 1}^{p c} , {K}_{A , k , i - 1}^{p c} , {K}_{k , i - 1}^{v s} , {θ}_{A dd , ref , k , i - 1}^{y a w} ]}^{T}$$
denotes a core control parameter input vector of the controller at the (i−1)-th prediction step of the k-th planning period;
$${K}_{P , k , i - 1}^{pc} , {K}_{I , k , i - 1}^{pc} , {K}_{A , k , i - 1}^{p c} , {K}_{k , i - 1}^{v s} , and {θ}_{A dd , ref , k , i - 1}^{y a w}$$
denote a proportional gain parameter of the blade pitch sub-control system, an integral gain parameter of the blade pitch sub-control system, a damping proportional gain of the floating platform, an optimal parameter of the generator torque sub-control system, and a correction angle of the nacelle yaw sub-control system at the (i−1)-th prediction step of the k-th planning period, respectively; d_{k,i-1}=[\tilde{v}_{wind}^{k,i-1}, \tilde{θ}_{wind}^{k,i-1}]^{T} denotes a disturbance input vector of the integrated planner at the (i−1)-th prediction step of the k-th planning period, wherein \tilde{v}_{wind}^{k,i-1} and \tilde{θ}_{wind}^{k,i-1} denote a measured wind speed and a measured wind direction at the (i−1)-th prediction step of the k-th planning period, respectively; and A_{k,i-1}, N_{k,i-1}, and B_{d,k,i-1} denote a state matrix, a core control parameter input matrix, and a disturbance input matrix at the (i−1)-th prediction step of the k-th planning period, respectively;
2) performing the multi-step prediction on the state variable based on the state equation obtained in the step 1), and limiting a prediction result within a constraint; and imposing a constraint on a finite control set of candidate given pitch angles, generator torques, and yaw angles of the floating wind turbines, as well as on the rotor speed, and pitch and roll angles of the floating platform, expressed as:
\dot{β}_{1,2,3,min}≤\dot{β}_{1,2,3}≤\dot{β}_{1,2,3,max} (14)
\dot{T}_{g,min}≤\dot{T}_{g}≤\dot{T}_{g,max} (15)
\dot{θ}_{yaw,min}≤\dot{θ}_{yaw}≤\dot{θ}_{yaw,max} (16)
ωᵣ^{cutin}≤ωᵣ≤ω_{r,rate} (17)
θ_{pitch,min}≤θ_{pitch}≤θ_{pitch,max} (18)
θ_{roll,min}≤θᵣₒₗₗ≤θ_{roll,max} (19)
wherein, \dot{β}_{1,2,3,min}, \dot{T}_{g,min}, \dot{θ}_{yaw,min}, θ_{pitch,min}, and θ_{roll,min} denote minimum constraints of the first-order derivatives of the three blade pitch angles, the first-order derivative of the generator torque, the first-order derivative of the nacelle yaw angle, the pitch angular velocity of the floating platform, and the roll angular velocity of the floating platform, respectively; \dot{θ}_{yaw,max}, θ_{pitch,max}, and θ_{roll,max} denote maximum constraints of the first-order derivative of the nacelle yaw angle, the pitch angular velocity of the floating platform, and the roll angular velocity of the floating platform, respectively;
$${ω}_{r}^{cutin}$$
denotes a minimum rotor speed corresponding to a cut-in wind speed; and ω_{r,rate} denotes the rated value of the rotor speed; and
3) substituting a predicted state vector of the floating wind turbines obtained in the step 2) into the comprehensive optimization objective function of the integrated planner of the floating wind turbines, and iteratively solving the comprehensive optimization objective function to obtain a control parameter vector
$${U}^{*} = [ {u}_{k , 0}^{*} , {u}_{k , 1}^{*} , … , {u}_{k , N - 1}^{*} ]$$
for the N planning periods corresponding to a minimum function value; and taking a first element
$${u}_{k}^{*}$$
in U* as the reference of the core control parameter for an existing industry-standard control system of the floating wind turbines.

17. The electronic device according to claim 9, wherein in the integrated plan-control method for dynamic stability of the floating wind turbines, the integrated planner comprises a fault recovery mechanism for ensuring normal operation in case of a fault or a communication problem in a control process; when the integrated planner fails to achieve an ideal control effect or communication between the controller and the integrated planner is interrupted, the integrated planner automatically cuts out and reverts to the controller; and when a control effect of the integrated planner is restored or the communication problem is resolved, a control mode of the integrated planner is automatically resumed.

18. The computer-readable storage medium according to claim 10, wherein in the integrated plan-control method for dynamic stability of the floating wind turbines, the step 1 comprises following steps:
1) establishing the controller, wherein the controller is an industry-standard controller for the floating wind turbine; an input into the controller comprises a measured rotor speed \tilde{ω}ᵣ, a measured wind speed \tilde{v}_{wind}, a measured wind direction \tilde{θ}_{wind}, and the core control parameter of the controller; and an output from the controller comprises three blade pitch angle references
$${β}_{1}^{*} , {β}_{2}^{*} and {β}_{3}^{*} ,$$
a generator torque reference
$${T}_{g}^{*} ,$$
and a nacelle yaw angle reference
$${θ}_{Y a w}^{*} ,$$
for controlling an operation of the floating wind turbines;
2) reconstructing the blade pitch sub-control system, the generator torque sub-control system, and the nacelle yaw sub-control system of the floating wind turbines, wherein the blade pitch sub-control system maintains the rotor speed or at the rated value ω_{r,rate} via proportional-integral (PI) and dynamically tunes structural damping of the floating platform in a pitch direction via proportional control; the generator torque sub-control system employs a segmented strategy, tracking maximum wind energy capture below a rated wind speed and maintaining a rated active power output P_{g,rate} above the rated wind speed by tuning a torque; and the nacelle yaw sub-control system operates at a fixed yaw rate γ to eliminate a deviation angle θₑ between a rotor plane and a wind direction, thereby improving wind energy capture efficiency, wherein γ>0;
3) establishing the integrated planner, wherein the integrated planner employs an optimization algorithm to iteratively search for an optimal core control parameter in real time; the core control parameter comprises: a proportional gain parameter
$${K}_{P}^{p c}$$
of the blade pitch sub-control system, an integral gain parameter
$${K}_{I}^{p c}$$
of the place pitch sub-control system, and a damping proportional gain
$${K}_{A}^{p c}$$
of the floating platform, an optimal parameter K^{vs} of the generator torque sub-control system, and a correction angle
$${θ}_{A dd , ref}^{y a w}$$
or the nacelle yaw sub-control system; an input into the integrated planner comprises a real-time operating state of the floating wind turbines measured by a sensor and a wind-wave-current environmental parameter; and the integrated planner outputs a core control parameter
$$u = {[ {K}_{P}^{p c} , {K}_{I}^{p c} , {K}_{A}^{p c} , {K}^{v s} , {θ}_{A dd , ref}^{y a w} ]}^{T} ,$$
for tuning the core control parameter of the controller; and
4) setting an execution period Tₚₗₐₙ of the integrated planner and a control period T_{ctrl} of the controller, wherein Tₚₗₐₙ=n*T_{ctrl}.

19. The computer-readable storage medium according to claim 18, wherein in the integrated plan-control method for dynamic stability of the floating wind turbines, in the step 1, the control strategy of the blade pitch sub-control system is expressed as:
$${β}_{1 , 2 , 3}^{*} = {β}_{1 , 2 , 3} + {K}_{P}^{p c} * {ω}_{e} + {K}_{I}^{p c} * {\int }_{0}^{T} {ω}_{e} d t + {K}_{A}^{p c} * {\tilde{\dot{θ}}}_{pitch} \qquad ( 2 )$$
wherein,
$${β}_{1 , 2 , 3}^{*}$$
denotes the blade pitch angle references; β_{1,2,3} denotes three real-time blade pitch angles; ωₑ=ω_{r,rate}−\tilde{ω}ᵣ denotes a rotor speed tracking error, and \tilde{ω}ᵣ denotes the measured rotor speed;
$${K}_{P}^{pc} , {K}_{I}^{pc} , and {K}_{A}^{pc}$$
denote a proportional gain coefficient of a pitch controller, an integral gain coefficient of the pitch controller, and a damping gain coefficient of the floating platform, respectively; \dot{\tilde{θ}}_{pitch} denotes a measured pitch angular velocity of the floating platform; and T denotes a cumulative operating time;
the control strategy of the generator torque sub-control system is to switch between a maximum wind energy capture strategy and a rated active power output strategy according to a blade pitch angle switching value β^{sw}, expressed as:
$$\{ \begin{matrix}{T}_{g}^{*} = {K}^{vs} * {{\tilde{ω}}_{r}}^{2} , {\tilde{β}}_{1 , 2 , 3} \leq {β}^{sw} \\ {T}_{g}^{*} = {P}_{g , rate} / ( {ω}_{r} {N}_{g} η ) , {\tilde{β}}_{1 , 2 , 3} > {β}^{sw}\end{matrix} \qquad ( 3 )$$
wherein,
$${T}_{g}^{*}$$
denotes the generator toque reference; \tilde{β}_{1,2,3} denotes measured blade pitch angles; K^{vs} denotes an optimal torque coefficient below the rated wind speed; N_{g} denotes a gearbox ratio; and η denotes energy conversion efficiency of a generator;
the control strategy of the nacelle yaw sub-control system is expressed as:
$${θ}_{yaw} = \{ \begin{matrix}+ γ & , {θ}_{e α} > {θ}_{th} \\ - γ & , {θ}_{e α} < - {θ}_{th} \\ 0 & , \vert {θ}_{e β} \vert < {θ}_{st}\end{matrix} \qquad ( 4 )$$
$${θ}_{yaw}^{*} = {θ}_{yaw} + {\dot{θ}}_{yaw} * {T}_{ctrl} \qquad ( 5 )$$
wherein, \dot{θ}_{yaw} denotes a nacelle yaw rate reference;
$${θ}_{yaw}^{*}$$
denotes the nacelle yaw angle reference; γ denotes a yaw rate setpoint; θₜₕ denotes an error threshold for yaw activation; θₛₜ=θₜₕ/2 denotes an error threshold for yaw deactivation;
$${θ}_{e α} = \frac{1}{a} {\sum }_{j = 1}^{a} {θ}_{e}^{j}$$
denotes an average value of a equally spaced data within a sliding window at a current time for triggering yaw activation, and
$${θ}_{e β} = \frac{1}{a} {\sum }_{j = 1}^{b} {θ}_{e}^{j}$$
denotes an average value of b equally spaced data within the sliding window at the current time for triggering yaw deactivation, a<b; and
$${θ}_{e}^{j}$$
denotes a comprehensive error at a j-th time interval, related to a yaw setpoint
$${θ}_{Add , ref , j}^{yaw}$$
at the j-th time interval, a measured wind direction
$${\tilde{θ}}_{wind}^{j}$$
at the j-th time interval, and a measured nacelle yaw angle
$${\tilde{θ}}_{nace}^{j}$$
at the j-th time interval,
$${θ}_{e}^{j} = {θ}_{Add , ref , j}^{yaw} + {\tilde{θ}}_{wind}^{j} - {\tilde{θ}}_{nace}^{j} .$$

20. The computer-readable storage medium according to claim 10, wherein in the integrated plan-control method for dynamic stability of the floating wind turbines,
the first-order derivatives \dot{β}_{1,2,3}^{k,i} of the pitch angles and the first-order derivative \dot{T}_{g}^{k,i} of the generator torque at the i-th prediction step of the k-th period are calculated as follows:
$${{\dot{β}}_{1 , 2 , 3}}^{k , i} = ( {β}_{1 , 2 , 3}^{* , k , i} - {β}_{1 , 2 , 3}^{k , i - 1} ) / {t}_{au - pit} \qquad ( 6 )$$
$${{\dot{T}}_{g}}^{k , i} = ( {T}_{g}^{* , k , i} - {T}_{g}^{k , i - 1} ) / {t}_{au - tor} \qquad ( )$$
wherein, tₐᵤ₋ₚᵢₜ and tₐᵤ₋ₜₒᵣ denote time constants of a blade pitch actuator and a generator torque actuator, respectively;
$${β}_{1 , 2 , 3}^{* , k , i} and {T}_{g}^{* , k , i}$$
denote predicted pitch angle references and a predicted generator torque reference at the i-th prediction step of the k-th period, respectively; and
$${β}_{1 , 2 , 3}^{k , i - 1} and {T}_{g}^{k , i - 1}$$
denote predicted pitch angle states and a predicted generator torque state at an (i−1)-th prediction step of the k-th period, respectively.
